(19) United States
(12) Patent Application Publication
(10) Pub. No.: US 2018/0265714 A1
(43) Pub. Date: Sep. 20, 2018

(54) Pelletized Thermoplastic Pavement Marking Compositions Using Glass Dust Filler

(71) Applicant: Potters Industries, LLC, Wilmington, DE (US)

(72) Inventor: Joseph L. Dotson, Pottstown, PA (US)

(21) Appl. No.: 15/921,894

(22) Filed: Mar. 15, 2018

Related U.S. Application Data
(60) Provisional application No. 62/471,536, filed on Mar. 15, 2017.

(51) Int. Cl. C09D 5/03; C08K 3/40

(52) U.S. Cl. CPC C09D 5/033; C08L 23/06; C08J 2300/22; C08K 3/40

(57) ABSTRACT

A pelletized thermoplastic road marking material is provided in which glass dust rather than calcium carbonate is used as the filler. Such glass dust can account for up to 55 weight % of the final formulation. Glass dust is a readily available and inexpensive byproduct of glass manufacturing which otherwise has little or no commercial value. Use of the glass dust is effective if the thermoplastic composition is prepared in pelletized form and performs comparably to a thermoplastic composition having calcium carbonate filler, while producing a higher yield.

### CROSS-REFERENCE TO RELATED APPLICATIONS

This patent application is related to and claims the benefit of priority to U.S. provisional patent application 62/471,536 filed on Mar. 15, 2017, the entire contents of which are incorporated herein by reference.

### BACKGROUND OF THE INVENTION

The present invention relates to the field of thermoplastic pavement markings and more particularly to the field of pelletized thermoplastic pavement marking compositions.

Road surface markings are used on paved roadways to provide guidance and information to drivers and pedestrians. Thermoplastic markers are some of the most common types of road markings. Thermoplastic coatings are generally homogeneous dry mixes of binder resins, plasticizers, glass beads (or other optics), pigments, and fillers. These types of markers demonstrate increased durability, lasting 3 to 6 years, and retro-reflectivity.

It has recently been shown that thermoplastic pavement marking compositions can be formed from pellets of homogenous compositions containing all of the ingredients of the desired pavement marking. This pelletized system is easier to use than the conventional powdered mix that is fed to the road marking apparatus for processing and ultimate application to the roadway.

Thermoplastic compositions have used calcium carbonate as the filler. Though satisfactory, the use of calcium carbonate does add cost to the final composition, especially considering that the filler makes up 55% by weight of the total formulation.

Glass particles, also known as dust, are a readily available byproduct produced in the manufacture of glass beads, including those of the sort used to provide retroreflectivity in roadway markings. There is generally no use for the glass dust and it is generally disposed in landfills. Given its ready availability and low cost, there is a desire to find some commercial use for this byproduct.

Efforts to use glass dust as a filler for thermoplastic compositions have not been successful. When used in powder form, the glass dust segregates and does not homogenously mix with the rest of the composition.

### SUMMARY OF THE INVENTION

It has been surprisingly found that glass dust can be successfully used as a filler in thermoplastic compositions if the thermoplastic is first produced in pelletized form and the pellets are then subsequently processed and applied by a road marking apparatus. Preferably, the glass dust has a size that is generally less than 210 microns and can be used as a partial or total replacement of calcium carbonate in the final thermoplastic mix. Thermoplastic compositions with glass dust filler melt at the same rate as those with calcium carbonate filler. In addition, thermoplastic compositions manufactured with glass dust demonstrate up to 8% higher yield when applied to a roadway.

### DETAILED DESCRIPTION OF THE PREFERRED EMBODIMENTS

Glass dust is a usually unwanted by product of glass bead manufacturing. When glass beads are produced from recycled glass, glass dust or powder is produced having a size smaller than 210 microns. If desired, the glass dust can be physically processed to reduce its size to below 45 microns. This glass dust has been considered to have no commercial value and is typically disposed of in landfills. Far from having any commercial value, this byproduct adds to the cost of production for glass beads because of the disposal costs.

It has been found that the performance of thermoplastic road marking compositions using glass dust exceed the performance of thermoplastic road marking compositions using standard calcium carbonate filler, provided that the thermoplastic is manufactured in pelletized form. U.S. Pat. No. 9,771,492, which is incorporated herein by reference, discusses the production of pelletized thermoplastic compositions using calcium carbonate as the filler. It has been found that when the thermoplastic composition is produced in pelletized form as described in U.S. Pat. No. 9,771,492, the glass dust does not segregate, but instead homogenously mixes with the rest of the composition.

### Experimental

A control set of thermoplastic pellets were prepared using calcium carbonate as a filler and an experimental set of thermoplastic pellets was prepared using glass dust as the filler. In addition to the filler, the formulations for both sets of pellets included resin, plasticizer and glass beads. The sets of pellets were separately melted at 450° F. and the yield rates for each set were measured. Because glass particles have a lower density than calcium carbonate, the yield as applied of the pellets having a glass dust filler was found to be 8% higher than that for the standard thermoplastic formulation.

A road trial was conducted using the control set and experimental set of thermoplastic pellets. Both sets of pellets took 80 minutes to melt 4000 pounds of pellets from cold, ambient temperature to 440° F. There were no adverse effects observed in the use of the pellets with the glass dust filler. For comparison purposes, thermoplastic in the form of powder was also tested, and the powder thermoplastic required twice as much time as the pellets to reach a temperature of 440° F. The results are set forth in Table 1 below.

TABLE 1

| | Time for 4000 lb. of |
|---|---|
| Thermoplastic | thermoplastic to reach 440° F. |
| Control pellets with CaCO₃ filler | 80 minutes |
| Pellets with glass dust filler | 80 minutes |
| Powder (Ozark) | 170 minutes |

Two separate tests were also performed to determine the specific gravity of thermoplastic pellets with varying replacement levels of glass dust for CaCO₃. The pellets were prepared using the ThermoDrop White TX Spray formulation. A control formulation and three experimental formulations having 25%, 50% and 100% replacement of the CaCO₃ filler with glass dust were prepared and viscosity measurements were taken at a temperature of 400° F. using a Brookfield SC4-27 spindle operating at speeds of 6 rpm, 12 rpm, 13 rpm and 60 rpm. Color measurements were taken using a Byk Gardner 45/0 spectrophotometer. Hardness, softening point and specific gravity measurements were also obtained. The measurements were taken on two separate samples at two separate facilities. The results of those measurements are reported in Tables 2 and 3 below.

TABLE 2

| | | 25% | 50% | 100% |
|---|---|---|---|---|
| | | Replacement | Replacement | Replacement |
| | | of Filler with | of Filler with | of Filler with |
| | Control | Glass Fill | Glass Fill | Glass Fill |
| Typical Formulation | % | | | |
| Resin | 15.30 | 15.30 | 15.30 | 15.30 |
| Plasticizer | 1.50 | 1.50 | 1.50 | 1.50 |
| HDPE | 2.50 | 2.50 | 2.50 | 2.50 |
| CoPolymer | 1.00 | 1.00 | 1.00 | 1.00 |
| Blue Film @ 2% Loading | 0.25 | 0.25 | 0.25 | 0.25 |
| TiO₂ Pigment | 10.50 | 10.50 | 10.50 | 10.50 |
| Glass Beads (Type 1 70% Round) | 35.00 | 35.00 | 35.00 | 35.00 |
| Flow Aid | 1.00 | 1.00 | 1.00 | 1.00 |
| Glass Fill (Filler) | | 8.26 | 16.52 | 33.03 |
| CaCO₃ Filler | 33.03 | 24.77 | 16.52 | |
| Binder (%) | 20.55 | 20.55 | 20.55 | 20.55 |
| Total (%) | 100.08 | 100.08 | 100.08 | 100.08 |
| Initial (400 F.) Viscosity | Initial (400 F.) Viscosity w/SC4-27 Spindle | | | |
| 6 RPM | 8042 | 8667 | 9708 | 10750 |
| 12 RPM | 5438 | 5813 | 6917 | 7333 |
| 13 RPM | 3633 | 3750 | 4917 | 4850 |
| 60 RPM | 2833 | 2950 | 3938 | 3758 |
| Color Measurement | Color Measurement w/Byk Gardner 45/0 | | | |
| Brightness-L* (C/2°) | 93.17 | 92.76 | 91.79 | 91.76 |
| Red/Green Color Scale-a* (C/2°) | −1.90 | −1.77 | −1.85 | −1.49 |
| Blue/Yellow Color Scale-b* | 2.09 | 3.01 | 3.41 | 3.14 |
| (C/2°) | | | | |
| Brightness Y (C/2°) | 83.34 | 82.43 | 80.24 | 80.18 |
| Color Coordinate-x (C/2°) | 0.3113 | 0.3132 | 0.3139 | 0.3139 |
| Coolor Coordinate-y (C/2°) | 0.3213 | 0.3230 | 0.3239 | 0.3231 |
| YD 1925 Yellowness Index (C/2°) | 2.83 | 4.73 | 5.48 | 5.26 |
| Shore A Hardness (115 F.) | 52 | 65 | 76 | 80 |
| Ring and Ball Softening Point (F.) | 222 | 226 | 226 | 226 |
| Weight in Air | 3.073 | 3.190 | 2.924 | 5.050 |
| Weight in Water | 1.508 | 1.569 | 1.446 | 2.528 |
| Specific Gravity | 2.038 | 2.034 | 2.022 | 1.998 |

TABLE 3

| | | 25% | 50% | 100% |
|---|---|---|---|---|
| | | Replacement | Replacement | Replacement |
| | | of Filler with | of Filler with | of Filler with |
| | Control | Glass Fill | Glass Fill | Glass Fill |
| Typical Formulation | % | | | |
| Resin | 15.30 | 15.10 | 14.90 | 14.80 |
| Plasticizer | 1.50 | 1.70 | 1.90 | 2.00 |
| HDPE | 2.50 | 2.50 | 2.50 | 2.50 |
| CoPolymer | 1.00 | 1.00 | 1.00 | 1.00 |
| Blue Film @ 2% Loading | 0.25 | 0.25 | 0.25 | 0.25 |
| TiO2 Pigment | 10.50 | 10.50 | 10.50 | 10.50 |
| Glass Beads (Type 1 70% Round) | 35.00 | 35.00 | 35.00 | 35.00 |
| Flow Aid | 1.00 | 1.00 | 1.00 | 1.00 |
| Glass Fill (Filler) | | 8.26 | 16.52 | 33.03 |
| CaCO3 Filler | 33.03 | 24.77 | 16.52 | |
| Binder (%) | 20.55 | 20.55 | 20.55 | 20.55 |
| Total (%) | 100.08 | 100.08 | 100.08 | 100.08 |
| Initial (400 F.) Viscosity | Initial (400 F.) Viscosity w/SC4-27 Spindle | | | |
| 6 RPM | 8042 | 8792 | 8708 | 9792 |
| 12 RPM | 5438 | 5792 | 5896 | 6521 |
| 13 RPM | 3633 | 3767 | 3892 | 4250 |
| 60 RPM | 2833 | 2829 | 3017 | 3233 |
| Color Measurement | Color Measurement w/Byk Gardner 45/0 | | | |
| Brightness-L* (C/2°) | 93.17 | 91.79 | 91.33 | 92.18 |
| Red/Green Color Scale-a* (C/2°) | −1.90 | −1.72 | −1.54 | −0.78 |
| Blue/Yellow Color Scale-b* | 2.09 | 2.47 | 3.19 | 4.60 |
| (C/2°) | | | | |
| Brightness Y (C/2°) | 83.34 | 80.23 | 79.22 | 81.11 |
| Color Coordinate-x (C/2°) | 0.3113 | 0.3123 | 0.3139 | 0.3176 |
| Color Coordinate-y (C/2°) | 0.3213 | 0.3220 | 0.3233 | 0.3254 |
| YD 1925 Yellowness Index (C/2°) | 2.83 | 3.75 | 5.33 | 8.63 |
| Shore A Hardness (115 F.) | 52 | 44 | 47 | 50 |
| Ring and Ball Softening Point (F.) | 222 | 221 | 222 | 222 |
| Specific Gravity | 2.076 | 2.037 | 2.061 | 2.030 |

The data in Tables 1 and 2 show that other than a change in viscosity, the replacement of CaCO₃ with glass dust showed no appreciable differences in the properties of the thermoplastic pellets.

It will be apparent to those skilled in the art that numerous modifications and variations of the described examples and embodiments are possible in light of the above teachings of the disclosure. Rather, various modifications may be made in the details within the scope and range of equivalents of the claims and without departing from the invention.

The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

Any documents referenced above are incorporated by reference herein. Their inclusion is not an admission that they are material or that they are otherwise prior art for any purpose.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Use of the term “about” should be construed as providing support for embodiments directed to the exact listed amount. No language in the specification should be construed as indicating any non-claimed element as essential to the practice of the invention.

Although the present invention has been described with respect to its application in highway marking paint compositions, it is to be distinctly understood that the present invention can be used in connection with other waterborne paints.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A filler for thermoplastic road marking material comprising glass particles having a particle size less than 210 microns.

2. The filler of claim 1, wherein the thermoplastic road marking is a pelletized thermoplastic road marking.

3. The filler of claim 2, wherein the filler comprises up to 55 weight % of the final thermoplastic road marking material.

4. The filler of claim 3, wherein the use of glass particles provides a higher yield compared to the use of a calcium carbonate filler.

5. The filler of claim 1, wherein the filler comprises up to 55 weight % of the final thermoplastic road marking material.

6. The filler of claim 5, wherein the use of glass particles provides a higher yield compared to the use of a calcium carbonate filler.

7. The filler of claim 1, wherein the use of glass particles provides a higher yield compared to the use of a calcium carbonate filler.

8. A thermoplastic composition having a filler comprising glass particles having a particle size less than 210 microns.

9. The thermoplastic composition of claim 8 wherein the thermoplastic composition is a thermoplastic road marking.

10. The thermoplastic composition of claim 9, wherein the filler comprises up to 55 weight % of the final thermoplastic composition.

11. The thermoplastic composition of claim 10, wherein the thermoplastic composition is a pellet.

12. The thermoplastic composition of claim 8, wherein the filler comprises up to 55 weight % of the final thermoplastic composition.

13. The thermoplastic composition of claim 8, wherein the thermoplastic composition is a pellet.

14. The thermoplastic composition of claim 13, wherein the filler comprises up to 55 weight % of the final thermoplastic composition.
